(19) United States
(12) Patent Application Publication
(10) Pub. No.: US 2023/0259516 A1
(43) Pub. Date: Aug. 17, 2023

(54) INFORMATION PROCESSING APPARATUS, INFORMATION PROCESSING METHOD, AND INFORMATION PROCESSING PROGRAM

(71) Applicant: FUJIFILM CORPORATION, Tokyo (JP)

(72) Inventors: Yasuhisa KANEKO, Tokyo (JP); Nobuya KITAMURA, Tokyo (JP); Tomohide HIRAGAMI, Tokyo (JP); Yasuyuki HOSONO, Tokyo (JP); Kenji NAGAMIYA, Tokyo (JP)

(21) Appl. No.: 18/167,091

(22) Filed: Feb. 10, 2023

(30) Foreign Application Priority Data
Feb. 16, 2022 (JP) 2022-022501

(51) Int. Cl. G06F 16/248; G06F 16/242; G06F 16/2457

(52) U.S. Cl. CPC G06F 16/248; G06F 16/2423; G06F 16/24575

(57) ABSTRACT

An information processing apparatus includes at least one processor, in which the processor receives a search objective target subject selected as a search objective from among a plurality of users, receives a search condition designated by a searcher, outputs a search result obtained by searching for a search target based on a keyword corresponding to the search condition and accumulates, as a search history, the keyword in association with a second user in a case in which a first user is the searcher and the search objective target subject is a second user, and reflects the search history to output of the search result obtained by searching the search target based on the keyword corresponding to the search condition.

### CROSS-REFERENCE TO RELATED APPLICATIONS

This application claims priority from Japanese Application No. 2022-022501, filed on Feb. 16, 2022, the entire disclosure of which is incorporated herein by reference.

### BACKGROUND

### Technical Field

The present disclosure relates to an information processing apparatus, an information processing method, and an information processing program.

### Related Art

In the related art, there is known the technology of searching for a search target based on a keyword corresponding to a search condition designated by a user and presenting a search result to the user. As the technology of obtaining the search result that is appropriate for the user, for example, JP2007-172375A discloses the technology of narrowing down a result obtained by searching a database that accumulates information on a search target in accordance with a classification item set by a user based on an input keyword, and outputting a search result for each classification item.

By the way, by designating the search condition by the user, the search result reflecting the intention of the user can be obtained. However, in the related art, it is difficult to obtain the search result reflecting the intention of a plurality of users.

### SUMMARY

The present disclosure has been made in view of the above circumstances, and is to provide an information processing apparatus, an information processing method, and an information processing program capable of outputting a search result reflecting the intention of a plurality of users as compared with a case in which a search history in a case in which a first user performs a search with a second user as a search objective target subject is accumulated and a search result is output without using a previous search history for a search by the second user.

In order to achieve the object described above, the present disclosure relates to an information processing apparatus that outputs a search result obtained by performing a search for a search target with any of a plurality of users including a first user and a second user as a searcher and based on a search condition designated by the searcher, the apparatus comprising at least one processor, in which the processor receives a search objective target subject selected as a search objective from among the plurality of users, receives the search condition designated by the searcher, outputs a search result obtained by searching for the search target based on a keyword corresponding to the search condition and accumulates, as a search history, the keyword in association with the second user in a case in which the first user is the searcher and the search objective target subject is the second user, and reflects the search history to output of the search result obtained by searching the search target based on the keyword corresponding to the search condition in a case in which the second user is the searcher.

In addition, in order to achieve the object described above, the present disclosure relates to an information processing method executed by a processor of an information processing apparatus that includes at least one processor and outputs a search result obtained by performing a search for a search target with any of a plurality of users including a first user and a second user as a searcher and based on a search condition designated by the searcher, the method comprising receiving a search objective target subject selected as a search objective from among the plurality of users, receiving the search condition designated by the searcher, outputting a search result obtained by searching for the search target based on a keyword corresponding to the search condition and accumulating, as a search history, the keyword in association with the second user in a case in which the first user is the searcher and the search objective target subject is the second user, and reflecting the search history to output of the search result obtained by searching the search target based on the keyword corresponding to the search condition in a case in which the second user is the searcher.

In addition, in order to achieve the object described above, the present disclosure relates to an information processing program causing a processor of an information processing apparatus that includes at least one processor and outputs a search result obtained by performing a search for a search target with any of a plurality of users including a first user and a second user as a searcher and based on a search condition designated by the searcher, to execute receiving a search objective target subject selected as a search objective from among the plurality of users, receiving the search condition designated by the searcher, outputting a search result obtained by searching for the search target based on a keyword corresponding to the search condition and accumulating, as a search history, the keyword in association with the second user in a case in which the first user is the searcher and the search objective target subject is the second user, and reflecting the search history to output of the search result obtained by searching the search target based on the keyword corresponding to the search condition in a case in which the second user is the searcher.

According to the present disclosure, the search result reflecting the intention of the plurality of users can be output as compared with a case in which the search history in a case in which the first user performs the search with the second user as the search objective target subject is accumulated and the search result is output without using the previous search history for the search by the second user.

### BRIEF DESCRIPTION OF THE DRAWINGS

FIG. 1 is a configuration diagram schematically showing an example of an overall configuration of a search system according to an embodiment.

FIG. 2 is a block diagram showing an example of a configuration of an information processing apparatus according to the embodiment.

FIG. 3 is a functional block diagram showing an example of a function of the information processing apparatus according to the embodiment.

FIG. 4A is a diagram showing an example of an attribute information DB.

FIG. 4B is a diagram for describing relationship information included in attribute information.

FIG. 5 is a diagram showing an example of a setting screen displayed on a display unit of the information processing apparatus according to the embodiment.

FIG. 6A is a diagram showing an example of the search screen displayed on the display unit of the information processing apparatus according to the embodiment.

FIG. 6B is a diagram for describing an example of a search screen in a case in which a searcher selects a search objective target subject in the embodiment.

FIG. 7A is a diagram for describing whether or not to accumulate a search history in a case in which the searcher and the search objective target subject have a relationship of a manager and a managed subject in the information processing apparatus according to the embodiment, and whether or not to reflect the search history.

FIG. 7B is a diagram for describing whether or not to accumulate a search history in a case in which the searcher and the search objective target subject have an equal relationship in the information processing apparatus according to the embodiment, and whether or not to reflect the search history.

FIG. 7C is a diagram for describing an example in which a relationship between the searcher and the search objective target subject can be optionally set in a usage environment in the information processing apparatus according to the embodiment.

FIG. 8 is a flowchart showing an example of a flow of information processing by the information processing apparatus according to the embodiment.

FIG. 9A is a flowchart showing an example of a flow of first processing executed in a case of the relationship of the manager and the managed subject in the information processing.

FIG. 9B is a flowchart showing an example of a flow of second processing executed in a case of the equal relationship in information processing.

FIG. 10 is a flowchart showing an example of a flow of information processing by an information processing apparatus according to a modification example 1.

FIG. 11 is a diagram showing an example of a search screen displayed on a display unit of an information processing apparatus according to a modification example 2.

### DETAILED DESCRIPTION

In the following, an embodiment of the disclosed technology will be described in detail with reference to the drawings. It should be noted that the present embodiment does not limit the present invention.

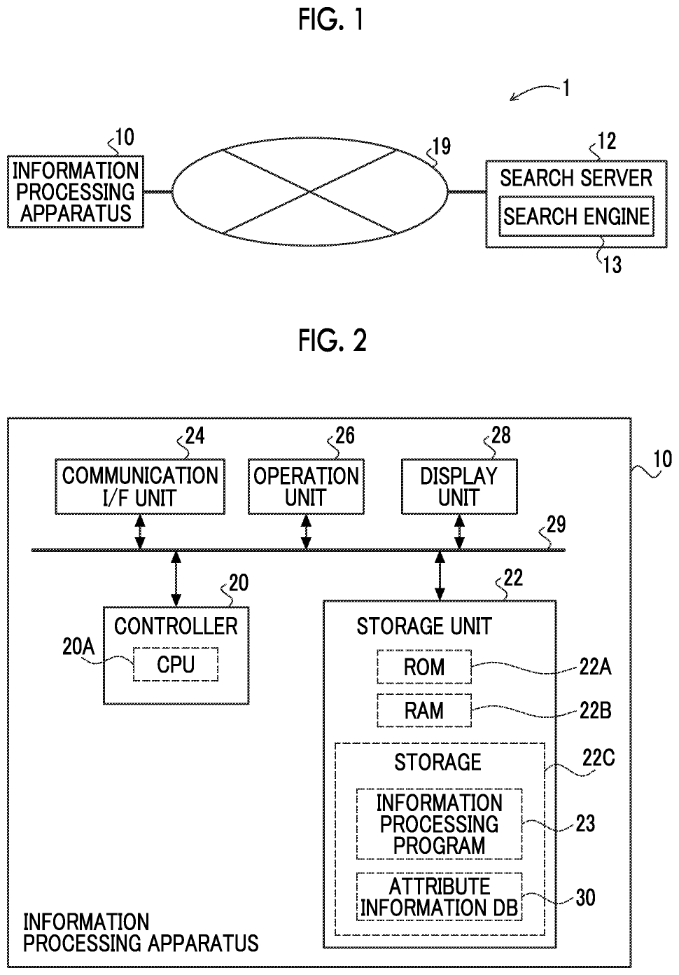

First, an example of an overall configuration of a search system according to the present embodiment will be described. FIG. 1 shows a configuration diagram showing an example of an overall configuration of a search system 1 according to the present embodiment. As shown in FIG. 1, the search system 1 according to the present embodiment comprises an information processing apparatus 10 and a search server 12. The information processing apparatus 10 and the search server 12 are connected to each other via a network 19 by wired communication or wireless communication. The search system 1 is a search system that performs search processing by using the search server 12 (search engine 13) provided in the network 19.

The search server 12 is a so-called server computer or a personal computer, and comprises the search engine 13. As the search engine 13, for example, an existing search engine, such as Yahoo! (registered trademark) or Google (registered trademark), can be used. The search server 12 has a function of providing a search result obtained by performing a search using the search engine 13 in response to a search request of the information processing apparatus 10 to the information processing apparatus 10 via the network 19. Specifically, the search server 12 receives a keyword as the search request from the information processing apparatus 10, and transmits information, such as a title or uniform resource locator (URL) indicating a website including the received keyword, among a plurality of websites (not shown) connected to the network 19 to the information processing apparatus 10, as the search result.

It should be noted that, in FIG. 1, the form has been described in which the search system 1 comprises one search engine 13, but the number of the search engines 13 provided in the search system 1 is not limited to one, and a plurality of search engines 13 may be provided. In this case, a plurality of search servers 12 each of which comprises the search engine 13 may be provided, or one search server 12 may comprise the plurality of search engines 13. In addition, the search server 12 may be restricted so that only a specific related party can access and perform a search by using a user identification (ID), a terminal ID, or the like.

On the other hand, the information processing apparatus 10 according to the present embodiment has a function of performing a search using the search server 12 via the network 19 in response to an instruction from a searcher and outputting the search result acquired from the search server 12. The information processing apparatus 10 may be, for example, a desktop computer, a laptop, a tablet computer, or a mobile terminal apparatus, such as a smartphone. It should be noted that the searcher may be a person to be determined by the information processing apparatus 10, for example, a logged-in user, and the information processing apparatus 10 may determine the searcher by using an ID or a password at the time of activation.

It should be noted that, in FIG. 1, the form has been described in which the search system 1 comprises one information processing apparatus 10, the number of the information processing apparatuses 10 provided in the search system 1 is not limited to one, and a plurality of information processing apparatuses 10 may be provided.

FIG. 2 is a diagram showing an example of a hardware configuration of the information processing apparatus 10. As shown in FIG. 2, the information processing apparatus 10 comprises a controller 20, a storage unit 22, a communication interface (I/F) unit 24, an operation unit 26, and a display unit 28. The controller 20, the storage unit 22, the communication I/F unit 24, the operation unit 26, and the display unit 28 are connected to each other via a bus 29, such as a system bus or a control bus, to allow exchange of various types of information.

The controller 20 according to the present embodiment controls the overall operation of the information processing apparatus 10. The controller 20 is a processor, and comprises a central processing unit (CPU) 20A. In addition, the controller 20 is connected to the storage unit 22 which will be described below.

The operation unit 26 is used for the searcher to input the instruction related to a search, various types of information, or the like. The operation unit 26 is not particularly limited, and examples thereof include various switches, a touch panel, a touch pen, and a mouse. It should be noted that the operation unit 26 may be configured as a voice input device using a microphone or the like. The display unit 28 displays the search result, various types of information, or the like. It should be noted that the operation unit 26 and the display unit 28 may be integrated to form a touch panel display.

The communication I/F unit 24 communicates various types of information including the search request, the search result, or the like using the search server 12 and the like via the network 19 by wireless communication or wired communication.

The storage unit 22 stores programs or various data used for the operation of the information processing apparatus 10. The storage unit 22 comprises, for example, a read only memory (ROM) 22A, a random access memory (RAM) 22B, and a storage 22C. Various programs and the like executed by the CPU 20A are stored in advance in the ROM 22A. The RAM 22B transitorily stores various data. The storage 22C stores an information processing program 23 executed by the CPU 20A, an attribute database (DB) 30, which will be described in detail below, or various types of other information. The information processing program 23 is a so-called search browser. The storage 22C is a non-volatile storage unit, and examples thereof include a hard disk drive (HDD) or a solid state drive (SSD).

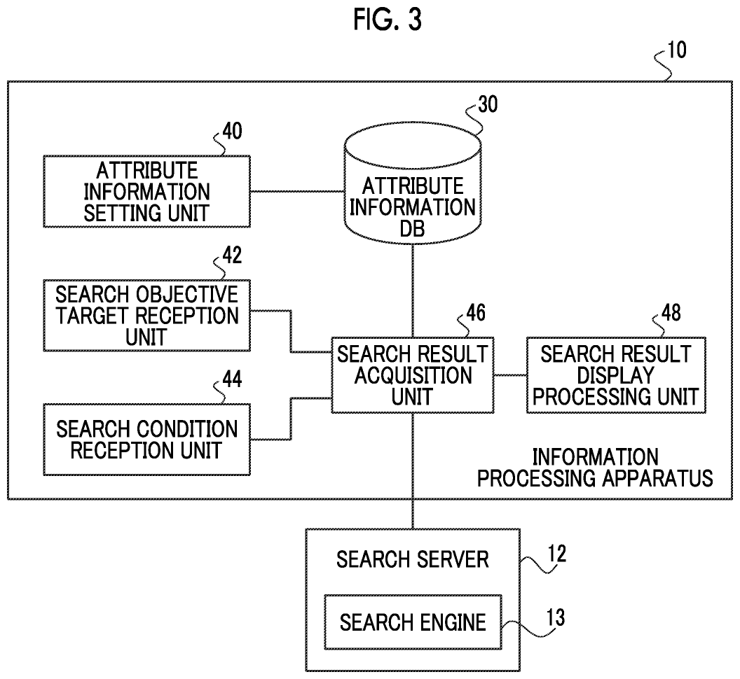

Further, FIG. 3 shows a functional block diagram of an example of the configuration of the information processing apparatus 10 according to the present embodiment. As shown in FIG. 3, the information processing apparatus 10 comprises an attribute information setting unit 40, a search objective target subject reception unit 42, a search condition reception unit 44, a search result acquisition unit 46, and a search result display processing unit 48. As an example, in the information processing apparatus 10 according to the present embodiment, the CPU 20A of the controller 20 executes the information processing program 23 stored in the storage 22C, so that the CPU 20A functions as the attribute information setting unit 40, the search objective target subject reception unit 42, the search condition reception unit 44, the search result acquisition unit 46, and the search result display processing unit 48.

The attribute information setting unit 40 has a function of setting the attribute information indicating the attribute of the target subject which is the search objective. In the information processing apparatus 10 according to the present embodiment, it is possible to obtain a search result corresponding to a specific user registered in advance in the information processing apparatus 10. In other words, it is possible to obtain the search result of the search performed for the specific user. For example, in a case in which the search for a leisure destination is performed, a desired search result differs depending on whether the specific user is an indoor person or an outdoor person. In such a case, in the information processing apparatus 10 according to the present embodiment, in such a case, in a case in which the specific user is the indoor person, the leisure destination for the indoor person is obtained as the search result by setting the attribute of the indoor person. On the other hand, in a case in which the specific user is the outdoor person, the leisure destination for the outdoor person is obtained as the search result by setting the attribute of the outdoor person. In addition, in the present embodiment, the “searcher” is a user who operates the information processing apparatus 10 and currently performs the search. In addition, in the present embodiment, the “search objective target subject” is the specific user assumed in a case in which the searcher performs the search. The “searcher” and the “search objective target subject” may or may not be the same. For example, in a couple, in a case in which, as the “searcher”, a husband searches for a gift for a wife, the wife is the “search objective target subject”, and thus the “searcher” and the “search objective target subject” are different from each other.

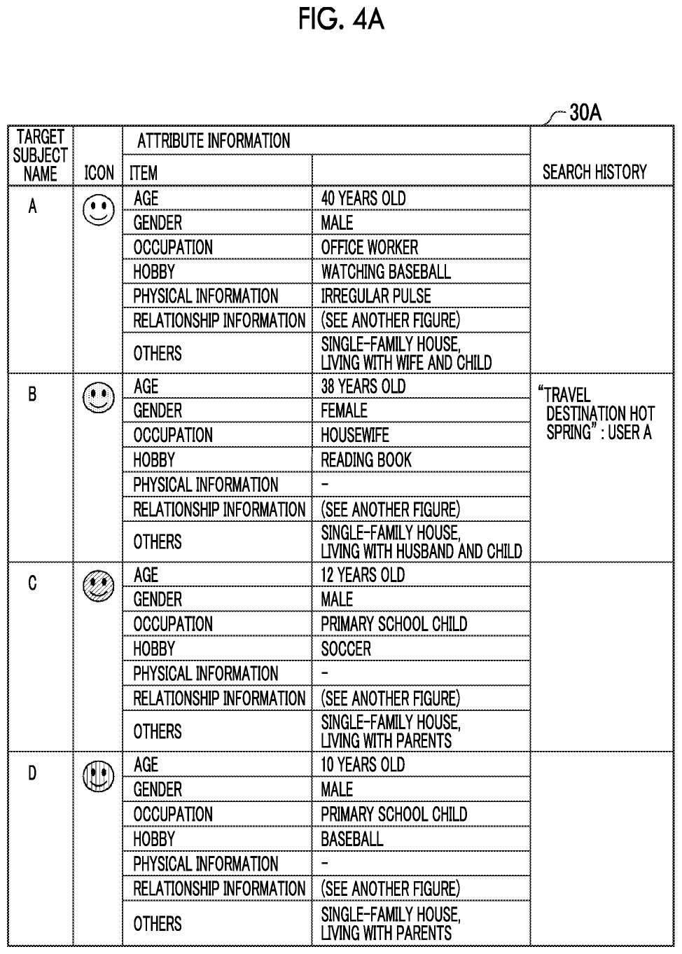

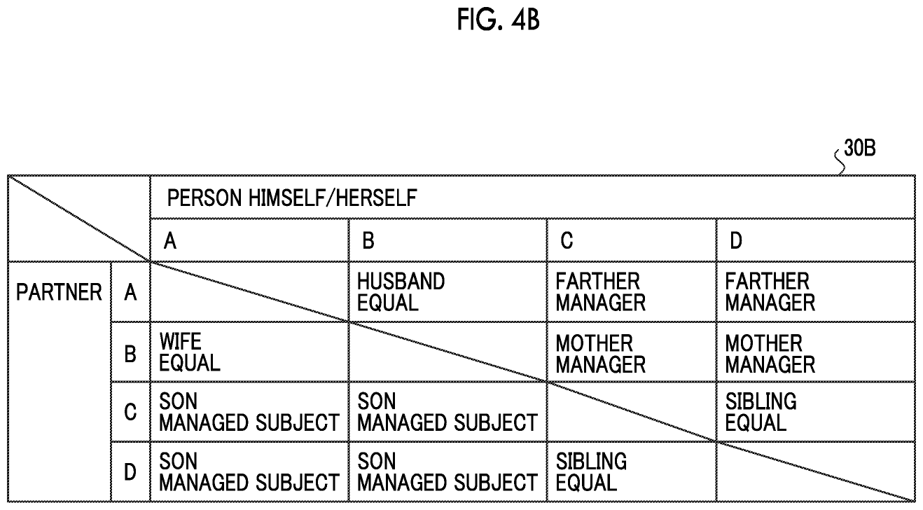

The attribute information set by the attribute information setting unit 40 is stored in the storage 22C as an attribute information DB 30. FIG. 4A shows an example of the attribute information DB 30 (30A). As shown in FIG. 4A, in the attribute information DB 30, the attribute information is associated with the name indicating each user and the icon indicating the user displayed on the search screen (details will be described below), for each user. As an example, in the attribute information included in the attribute information DB 30A shown in FIG. 4A, the information indicating the attribute of the user is set for each of a plurality of items.

In the example shown in FIG. 4A, as items of the attribute, seven of “age”, “gender”, “occupation”, “hobby”, “physical information”, “relationship information”, and “others” are adopted. Among the items, “age” is an age of the user, “gender” is a gender of the user, and “occupation” is an occupation of the user. In addition, among the items, “hobby” is a hobby of the user, and “physical information” is information on a body of the user, for example, information on health. In addition, among the items, the “relationship information” is information indicating a relationship among a plurality of users set in the attribute information DB 30. As an example, in the present embodiment, regarding the relationship among the plurality of users, any of the connection and whether or not the manager and the managed subject has an equal relationship is used. FIG. 4B shows an example of relationship information 30B. The relationship information 30B is information indicating the relationship between other users as seen from the user himself/herself. In the example shown in FIG. 4B, in a case in which the user A is the person himself/herself, the user B has a relationship of a “wife” and “equal”, the user C has a relationship of a “son” and “managed subject”, and the user D has a relationship of a “son” and “managed subject”.

In addition, among the items of the attribute information shown in FIG. 4A, “others” is information on the attribute of the user, which is not classified into each of the items described above. Examples of the attribute information that is regarded as “others” include a living environment (living environment), such as a single-family house or an apartment complex, living alone or having a co-resident, but the present disclosure is not particularly limited. It should be noted that the item of the attribute information shown in FIG. 4A is an example, the number and types of the items are not particularly limited, and it is not necessary to set the item in the attribute information.

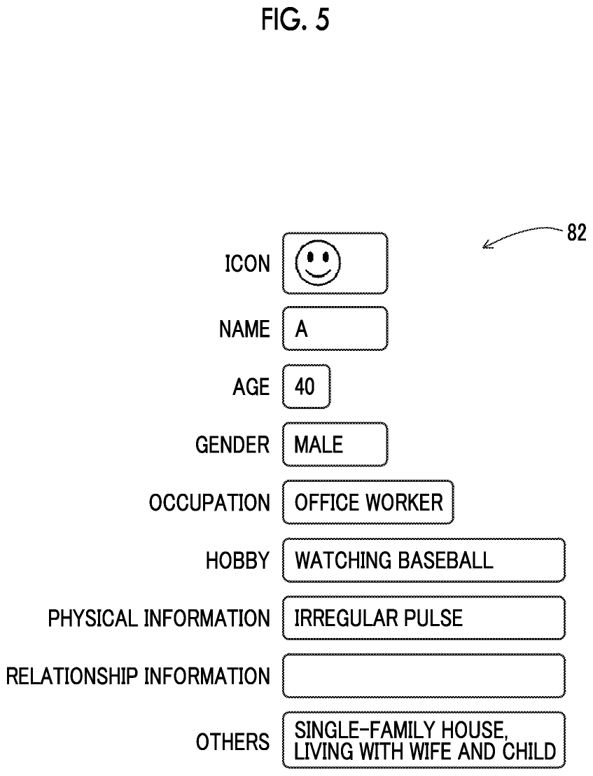

The attribute information setting unit 40 has a function of setting such attribute information in the attribute information DB 30 for each user. It should be noted that a method by which the attribute information setting unit 40 sets the attribute information for each user by is not particularly limited. As an example, the attribute information setting unit 40 according to the present embodiment displays the setting screen 82 shown in FIG. 5 as an example on the display unit 28, and sets the attribute information input by the user performing the setting in accordance with the setting screen 82 using the operation unit 26 in the attribute information DB 30. It should be noted that a method of inputting the attribute information on the setting screen 82 is not particularly limited. For example, a form may be adopted in which the user who performs the setting may freely input the attribute information, or a form may be adopted in which, in a case in which each item is clicked, the types of the attributes that can be set are displayed as a pull-down menu, and the type of the attribute corresponding to the user is selected from among the types of the attributes.

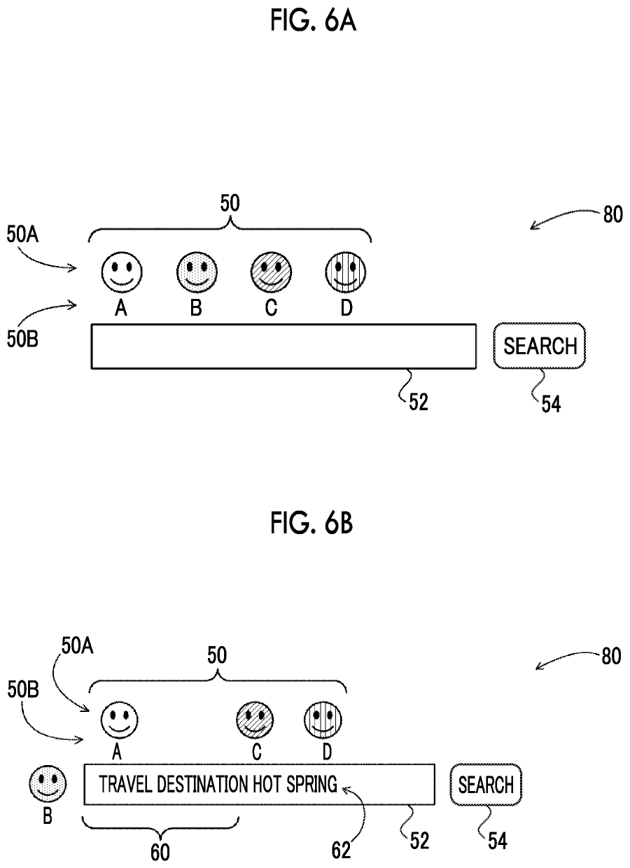

The search objective target subject reception unit 42 has a function of receiving a search objective subject selected as a search objective. Specifically, the search objective target subject reception unit 42 has a function of displaying user identification information 50 indicating the user described above in a search screen 80 shown in FIG. 6A as an example, and receiving the search objective target subject which is the current search objective selected by the searcher from among users displays in the user identification information 50.

FIG. 6A shows an example of the search screen 80 displayed on the display unit 28. As shown in FIG. 6A, the search screen 80 includes the user identification information 50 for identifying the user who can be the search objective, the input field 52, and the search button 54. The user identification information 50 includes an icon 50A indicating the user and a name 50B indicating a name of the user.

The searcher selects the search objective target subject by, on the search screen 80, dragging and dropping the icon 50A indicating the user corresponding to the search objective target subject in the current search from the user identification information 50 to the side of the input field 52 or clicking the icon 50A by the operation unit 26. FIG. 6B shows an example of the search screen 80 in a case in which the searcher selects one search objective target subject. Specifically, FIG. 6B shows a state in which the “user B” is selected by the searcher as the search objective target subject.

In this way, the search objective target subject reception unit 42 receives the user corresponding to the icon 50A to which the searcher drags and drops as the search objective target subject. The search objective target subject reception unit 42 outputs the received information indicating the search objective target subject to the search result acquisition unit 46.

The search condition reception unit 44 has a function of receiving the search condition designated by the searcher. Specifically, the search condition reception unit 44 has a function of receiving a keyword 62 input by the searcher to the input field 52 by operating the operation unit 26 on the search screen 80, as a search condition 60. In the examples shown in FIG. 6B, as the keyword 62, a state is shown in which the searcher inputs two keywords 62 of “travel destination” and “hot spring”. It should be noted that the keyword 62 to be input to the input field 52 is not particularly limited and may be, for example, any of a word or a sentence, and the number of the keywords 62 that can be input to the input field 52 is not particularly limited. The search condition reception unit 44 outputs information indicating the received search condition 60 to the search result acquisition unit 46.

The search result acquisition unit 46 acquires the search result obtained by the search using the search engine 13 based on a plurality of keywords corresponding to the attribute information set for the search objective target subject received by the search objective target subject reception unit 42 and the search condition 60 received by the search condition reception unit 44.

In addition, the search result acquisition unit 46 according to the present embodiment has a function of accumulating the search history in association with the search objective target subject in the search and a function of reflecting the search history associated with the search objective target subject, and determines whether or not to accumulate the search history and whether or not to reflect the search history in accordance with the relationship between the searcher and the search objective target subject.

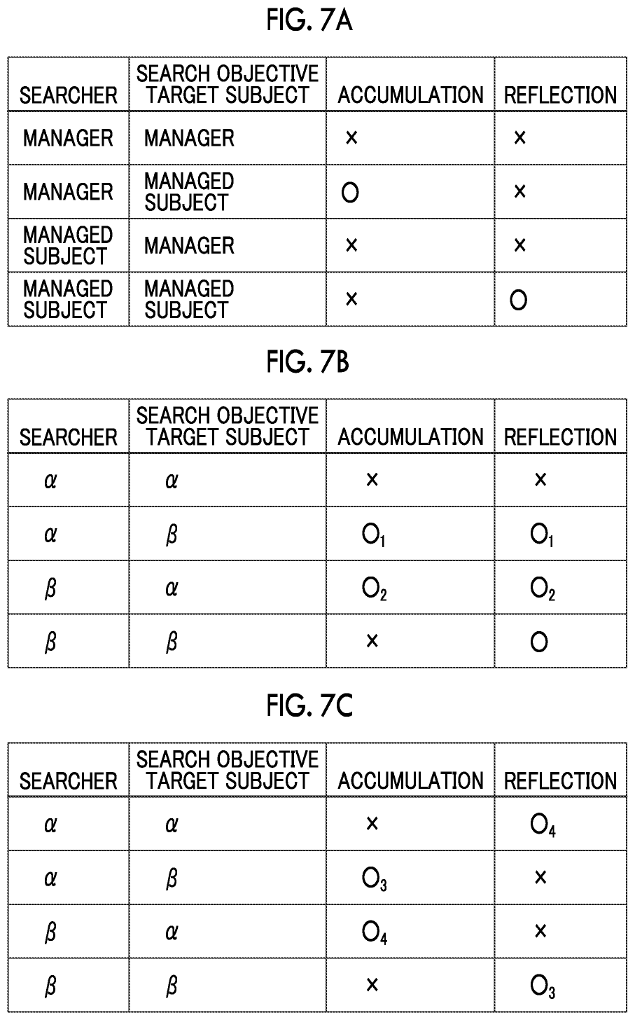

It should be noted that, here, the relationship between two users will be described. In the relationship between the manager (user A in FIG. 4A) and the managed subject (user C in FIG. 4A), the search history is accumulated in a case in which the user A who is the manager as the searcher performs the search for the user C who is the managed subject as the search objective target subject. This case corresponds to a case in which the searcher=the manager and the search objective target subject=the managed subject in FIG. 7A, and is “o”. In addition, in a case in which the user C, who is the managed subject as the searcher, performs the search for the user C himself/herself, who is the managed subject as the search objective target subject, the accumulated search history performed by the user A for the user C is reflected. This case above corresponds to a case in which the searcher=the managed subject and the search objective target subject=the managed subject, and the reflection is “o”. It should be noted that, in other cases, the search history is not accumulated and the accumulated search history is not reflected.

On the other hand, FIG. 7B shows a diagram for describing whether or not to accumulate the search history in a case in which the searcher and the search objective target subject have the equal relationship, and whether or not to reflect the search history. In FIG. 7B, “a” is any one of the specific users (users 1 to 4 in the present embodiment) registered in advance in the information processing apparatus 10, and “β” is any one of the users (users 1 to 4 in the present embodiment) set in the information processing apparatus 10 and indicates the user different from “α”. In addition, as in FIG. 7A, “∘” indicates that the accumulation or the reflection is performed, and “x” indicates that the accumulation or the reflection is not performed.

As shown in FIG. 7B, the search performed by the user a as the searcher for the user β as the search objective subject is accumulated as a first search history, and the accumulated first search history is reflected in a case in which the user α as the searcher performs the search for the user β as the search objective subject. This relationship is represented by “∘₁” in FIG. 7B. Similarly, the search performed by the user β as the searcher for the user α as the search objective subject is accumulated as a second search history, and the accumulated second search history is reflected in a case in which the user β as the searcher performs the search for the user α as the search objective subject. This relationship is represented by “∘₂” in FIG. 7B. That is, in the case of FIG. 7B, the accumulation and the reflection are performed in a case in which the searcher and the search objective target subject have the same relationship, and the reflection in the previous case of the manager-managed subject is not performed.

It should be noted that these relationships are not fixed and can be optionally set under the usage environment between the users. For example, even in a case of the equal relationship, the mutual reflection can be performed. As shown in FIG. 7C, the search performed by the user α as the searcher for the user β as the search objective subject is accumulated as a third search history, and the accumulated third search history is reflected in a case in which the user β as the searcher performs the search for the user β as the search objective subject. This relationship is represented by “∘₃” in FIG. 7C. Similarly, the search performed by the user β as the searcher for the user α as the search objective subject is accumulated as a fourth search history, and the accumulated fourth search history is reflected in a case in which the user α as the searcher performs the search for the user α as the search objective subject. This relationship is represented by “∘₄” in FIG. 7C. In this way, the search history can be shared between the users α and β, which is shown in FIG. 7C, the accumulation in which the searcher-search objective target subject is α-β is reflected to β-β, and the accumulation in which the searcher-search objective target subject is β-α is reflected to α-α.

Specifically, the search result acquisition unit 46 acquires the attribute information set for the search objective target subject received by the search objective target subject reception unit 42 from the attribute information DB 30, and specifies the acquired attribute information as the keyword. In addition, the search result acquisition unit 46 specifies the keyword 62 included in the search condition 60 received by the search condition reception unit 44 as the keyword. Further, the search result acquisition unit 46 transmits the search request to the search server 12. In a case in which the search history is reflected based on the relationship between the searcher and the search objective target subject, the search request includes the keyword specified from the search history, the keyword specified from the attribute information, and the keyword specified from the search condition 60. On the other hand, in a case in which the search history is not reflected, the keyword specified from the attribute information and the keyword specified from the search condition 60 are included. In the search server 12, the search is performed using the search engine 13 based on a plurality of keywords included in the search request received from the information processing apparatus 10, and the search result is transmitted to the information processing apparatus 10. As described above, the search result is, for example, the information, such as the title or the URL indicating the website including the keyword included in the received search request.

The search result acquisition unit 46 receives the search result transmitted by the search server 12 and outputs the received search result to the search result display processing unit 48.

The search result display processing unit 48 has a function of displaying the search result on the display unit 28. It should be noted that a method by which the search result display processing unit 48 displays the search result on the display unit 28 is not particularly limited.

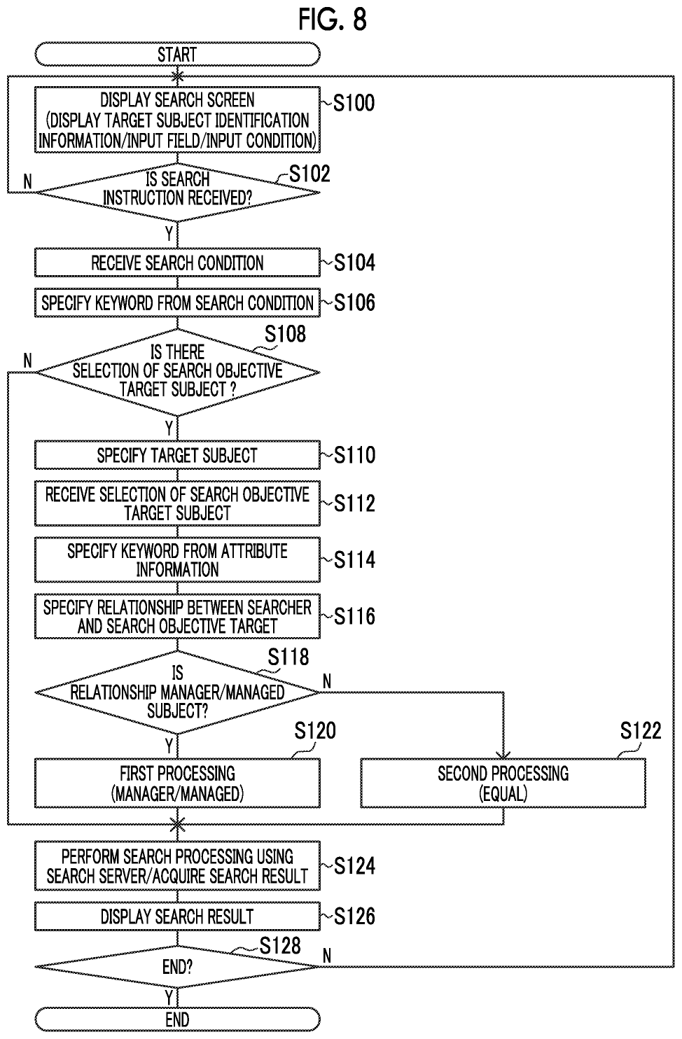

Next, an action of the information processing apparatus 10 according to the present embodiment will be described with reference to the drawings. FIG. 8 shows a flowchart showing an example of a flow of information processing executed by the information processing apparatus 10 according to the present embodiment. The information processing apparatus 10 according to the present embodiment executes the information processing shown in FIG. 8 by the CPU 20A of the controller 20 executing the information processing program 23 stored in the storage 22C based on the instruction or the like of the searcher performed by the operation unit 26, as an example. It should be noted that, before executing the information processing shown in FIG. 8, as described above, the attribute information setting unit 40 sets the attribute information related to the attribute of the target subject in the attribute information DB 30 stored in the storage 22C.

In step S100 of FIG. 8, the search screen 80 is displayed. The search objective target subject reception unit 42 displays the user identification information 50 on the search screen 80. In addition, the search condition reception unit 44 displays the input field 52 on the search screen 80.

As described above, the searcher operates the operation unit 26 to select the search objective target subject from the user identification information 50 on the search screen 80. In addition, the searcher operates the operation unit 26 to input the keyword 62 that is the search condition 60 to the input field 52. After the selection of the search objective target subject and the input of the search condition 60 end, the searcher operates the search button 54 to instruct the execution of the search.

In next step S102, it is determined whether or not a search instruction is received. Until the search instruction is received, in other words, until the searcher operates the search button 54 to instruct the execution of the search, a negative determination is made in the determination in step S102, and the processing returns to step S100. On the other hand, in a case in which the search instruction is received, a positive determination is made in the determination in step S102, and the processing proceeds to step S104.

In next step S104, the search condition reception unit 44 receives the search condition 60 input to the input field 52 of the search screen 80, as described above. In next step S106, the search result acquisition unit 46 specifies the keyword 62 to be used for the search from the received search condition 60, as described above. In the form shown in FIG. 6B, the two keywords 62 of “travel destination” and “hot spring” are specified from the search condition 60.

In next step S108, it is determined whether or not there is the selection of the search objective target subject. In the present embodiment, it is possible to perform the search without selecting the search objective target subject. So to speak, in the search system 1 according to the present embodiment, a general-purpose search can be performed without assuming the search objective target subject. In this case, the searcher inputs the keyword 62 that is the search condition 60 to the input field 52 without selecting the search objective target subject. On the other hand, as shown in FIG. 6B, in a case in which the search objective target subject is selected, a positive determination is made in the determination in step S108, and the processing proceeds to step S110.

In step S110, the search result acquisition unit 46 specifies which of the specific users (users 1 to 4 in the present embodiment) registered in advance the searcher is. It should be noted that a method by which the search result acquisition unit 46 specifies the searcher is not particularly limited. For example, the user identification information, such as a user identifier (ID) is stored in advance for each user, and the search result acquisition unit 46 may acquire the user identification information of the searcher to specify which of the specific users registered the searcher is, based on the stored user identification information.

In next step S112, the search objective target subject reception unit 42 receives the selection of the search objective target subject as described above. For example, in the form shown in FIG. 6B, the “user B” is received as the search objective target subject.

In next step S114, as described above, the search result acquisition unit 46 specifies the keyword to be used for the search from the attribute information indicating the attribute of the selected search objective target subject with reference to the attribute information DB 30.

In next step S116, the search result acquisition unit 46 specifies the relationship between the searcher specified in step S110 and the search objective target received in step S112. Specifically, the search result acquisition unit 46 specifies the relationship between the searcher and the search objective target subject with reference to the relationship information 30B included in the attribute information DB 30 stored in the storage 22C. For example, in a case in which the searcher is the user A and the search objective target subject is the user B, the relationship is “equal”. In addition, for example, in a case in which the searcher is the user A and the search objective target subject is the user C, the relationship is the “manager/managed subject” in which the manager is the user A and the managed subject is the user C.

In next step S118, the search result acquisition unit 46 determines whether or not the relationship specified in step S116 is the manager/managed subject. In a case in which the relationship is the manager/managed subject, a positive determination is made in step S118, and the processing proceeds to step S120.

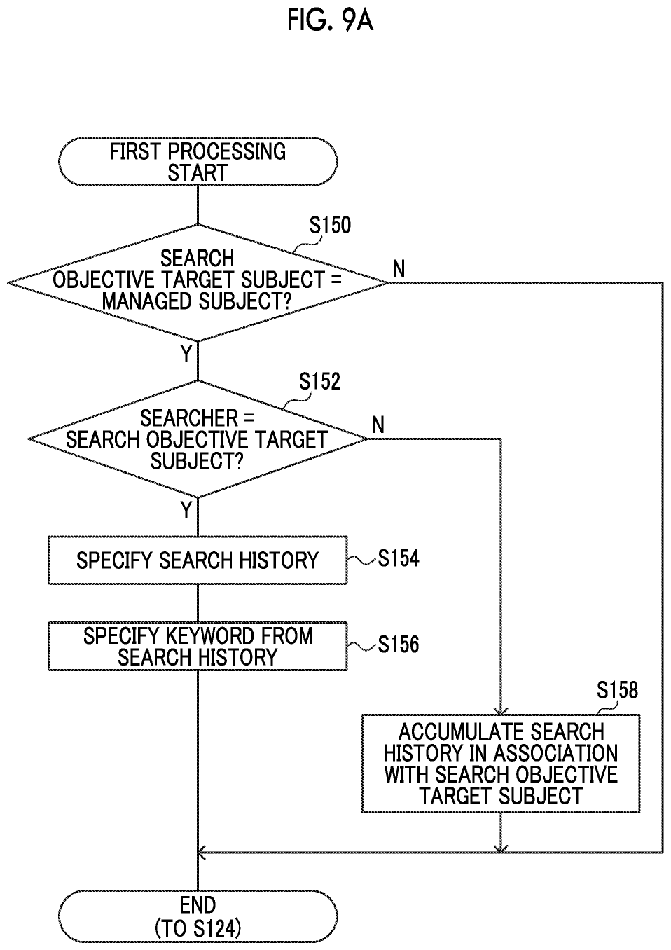

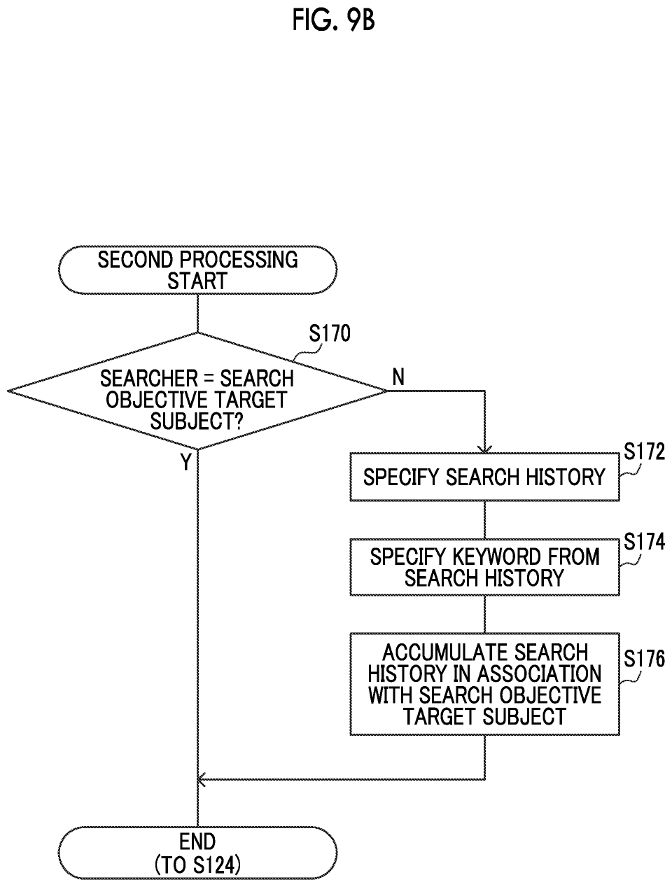

In step S120, the search result acquisition unit 46 executes first processing shown in FIG. 9A as an example.

In step S150 of the first processing shown in FIG. 9A, the search result acquisition unit 46 determines whether or not the search objective target subject is the managed subject. In a case in which the search objective target subject is not the managed subject, in other words, in a case in which the search objective target subject is the manager, a negative determination is made in the determination in step S150, and the first processing shown in FIG. 9A ends. As a result, step S120 of the information processing (see FIG. 8) ends, and the processing proceeds to step S124.

On the other hand, in a case in which the search objective target subject is the managed subject, a positive determination is made in the determination in step S150, and the processing proceeds to step S152.

In step S152, the search result acquisition unit 46 determines whether or not the searcher and the search objective target subject are the same. In a case in which the searcher and the search objective target subject are not the same, that is, in a case in which the searcher is the manager and the search objective target subject is the managed subject, a negative determination is made in the determination, and the processing proceeds to step S158.

In step S158, the search result acquisition unit 46 accumulates the keyword to be used for the specified search as the search history in association with the search objective target subject. Specifically, the search result acquisition unit 46 accumulates the keyword specified in step S106 and the keyword specified in step S114 in association with the search objective target subject. As an example, as shown in FIG. 4A, the search result acquisition unit 46 according to the present embodiment accumulates the search history in the attribute information DB 30 in association with the user. It should be noted that, the search result acquisition unit 46 further accumulates the information, which indicates who is the searcher in the search, in association with the search history. It should be noted that FIG. 4A shows a state in which “travel destination hot spring” are accumulated for the user B as the search history in a case in which the searcher is the user A. In a case in which the processing of step S158 ends, the first processing shown in FIG. 9A ends. As a result, step S120 of the information processing (see FIG. 8) ends, and the processing proceeds to step S124.

On the other hand, in step S152, in a case in which the searcher and the search objective target subject are the same, that is, in a case in which the searcher and the search objective target subject are the managed subjects, a positive determination is made, and the processing proceeds to step S154. In step S154, the search result acquisition unit 46 specifies the search history associated with the search objective target subject with reference to the attribute information DB 30 stored in the storage 22C. Specifically, among the search histories associated with the search objective target subject, the search history associated with the current searcher as the searcher is specified.

In next step S156, the search result acquisition unit 46 specifies the keyword to be used for the search from the search history specified in step S154. As an example, the search result acquisition unit 46 according to the present embodiment extracts a keyword having a high relation to the keyword 62 included in the current search condition 60 from the plurality of keywords included in the search history, and specifies the extracted keyword as the keyword to be used for the current search.

The keyword having a high relation may be extracted by performing a similarity analysis among the plurality of keywords included in the search history and the keyword 62 included in the current search condition 60. For example, the sentence or keyword used as the related-search history is extracted by performing the similarity analysis between the sentence or keyword included in the search condition 60 and the sentence or keyword included in the search history. In the similarity analysis, for example, a rate of match between the keyword included in the search condition 60 and the keyword included in the search history is analyzed, and the keyword having a high rate of match is extracted as the keyword having a high relation to the keyword 62 included in the current search condition 60. It should be noted that, the keyword having a high rate of match may be a keyword having the largest number of matching. In addition, the keyword having a high rate of match may be a keyword in which the number of matching is equal to or greater than a predetermined reference value. It should be noted that the reference value may be a set value set in advance, or an input value input by the user.

In addition, the sentence or keyword included in the search condition 60 and the sentence or keyword included in the search history are subjected to the similarity analysis, but the present disclosure is not limited to this. A sentence or a word describing the meaning or concept of a word in the sentence or keyword included in the search condition 60 or the search history may be acquired from a dictionary site, such as Wikipedia, to perform the similarity analysis by using the acquired sentence or the like describing the meaning or concept. For example, the similarity analysis may be performed between the sentence or the like describing the meaning or concept of the keyword and the sentence or the like describing the meaning or concept of the keyword in the search history to use the keyword corresponding to the sentence or the like describing similar meaning or concept as the keyword having a high relation to the keyword 62 included in the current search condition 60.

In addition, the similarity analysis is not limited to the rate of match between words, and systematized information in which keywords are systematized (ontology) may be stored and the systematized information may be used. The systematized information defines the concept, a usage, and a convention for describing the keyword. For example, “lunch” is a subordinate operation of “meal”, and “Italian food” is a subordinate operation of lunch, that is, the systematization can be made into a relationship of “meal”−“lunch”−“Italian food”. In a case in which “lunch Chinese food” is input as the keyword, the same word may be found in a systematized dictionary (lunch in this case) to determine from the hierarchical relationship whether or not the search has the same objective and to extract the keyword having a high rate of match. Further, the similarity analysis may be performed by vectorization of the sentence, the keyword, or the like by natural language processing such as latent semantic indexing (LSI) and comparing the vectors.

In a case in which the processing of step S156 ends, the first processing shown in FIG. 9A ends. As a result, step S120 of the information processing (see FIG. 8) ends, and the processing proceeds to step S124.

On the other hand, in S118, in a case in which the relationship is not the manager/managed subject, in other words, in a case in which the relationship is equal, a negative determination is made in step S118, and the processing proceeds to step S122.

In step S122, the search result acquisition unit 46 executes second processing shown in FIG. 9B as an example.

In step S170 of the second processing shown in FIG. 9B, the search result acquisition unit 46 determines whether or not the searcher and the search objective target subject are the same. In a case in which the searcher and the search objective target subject are not the same, that is, in a case in which the searcher and the search objective target subject are different, a negative determination is made in the determination, and the processing proceeds to step S172.

In step S172, as in step S154 of the first processing (see FIG. 9A) described above, the search result acquisition unit 46 specifies the search history associated with the search objective target subject with reference to the attribute information DB 30 stored in the storage 22C. Specifically, among the search histories associated with the search objective target subject, the search history associated with the current searcher as the searcher is specified.

In next step S174, as in step S156 of the first processing (see FIG. 9A) described above, the search result acquisition unit 46 specifies the keyword 62 to be used for the search from the search history specified in step S154.

In next step S176, as in step S158 of the first processing (see FIG. 9A) described above, the search result acquisition unit 46 accumulates the keyword to be used for the specified search in association with the search objective target subject as the search history. Specifically, the search result acquisition unit 46 associates the keyword specified in step S106 and the keyword specified in step S114 with the search objective target subject, and accumulates the keywords also in association with the information, which indicates who is the searcher in the search in the attribute information DB 30 stored in the storage 22C. In a case in which the processing of step S176 ends, the second processing shown in FIG. 9B ends. As a result, step S122 of the information processing (see FIG. 8) ends, and the processing proceeds to step S124.

On the other hand, in step S170, in a case in which the searcher and the search objective target subject are the same, a positive determination is made, and the second processing shown in FIG. 9B ends. As a result, step S122 of the information processing (see FIG. 8) ends, and the processing proceeds to step S124.

In step S124, as described above, the search result acquisition unit 46 performs the search processing using the search engine 13 of the search server 12 and acquires the search result from the search server 12. Specifically, the search result acquisition unit 46 transmits the search request to the search server 12 via the network 19, and receives the search result by the search engine 13 from the search server 12 via the network 19.

In next step S126, the search result display processing unit 48 displays the search result acquired in step S124 on the display unit 28.

In next step S128, it is determined whether or not the information processing shown in FIG. 8 ends. As an example, in the present embodiment, until a predetermined end condition is satisfied, a negative determination is made in the determination in step S128, the processing returns to step S100, and the processing of steps S100 to S126 is repeated.

On the other hand, in a case in which the predetermined end condition, such as reception of an instruction to end the search by the searcher, is satisfied, a positive determination is made in the determination in step S128, and the information processing shown in FIG. 8 ends.

The present embodiment described above is an example of the technology of the present disclosure, and various modification examples can be made. For example, the following modification examples and the like may be made.

### Modification Example 1

In the form described above, the form has been described in which the search history is reflected to the search by including the keyword specified from the search history in the search request. However, a method of reflecting the search history is not limited to this form. For example, a form may be adopted in which the search result display processing unit 48 displays the search result on the display unit 28 in a priority order corresponding to the relation to the keyword specified from the search history.

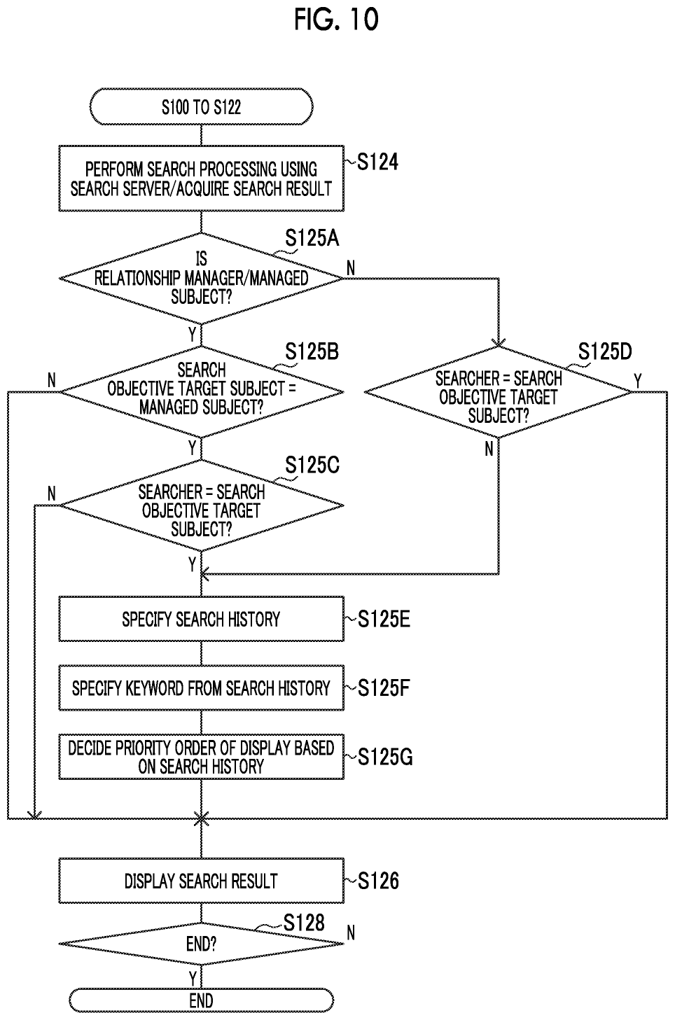

FIG. 10 shows a flowchart showing an example of a flow of the information processing by the information processing apparatus in the present form. It should be noted that, each processing of step S100 to step S124 is the same as step S100 to step S124 of the information processing (see FIG. 8) described above in the embodiment except that a part of the first processing of step S120 and a part of the second processing of step S122 are different, and thus the description of steps S100 to S122 in FIG. 10 will be omitted.

It should be noted that, in the first processing according to the present modification example, steps S154 and S156 of the first processing (see FIG. 9A) described above in the embodiment are omitted. In addition, in the second processing according to the present modification example, steps S172 and S174 of the second processing (see FIG. 9B) described above in the embodiment are omitted. That is, in the first processing and the second processing according to the present modification example, the search history associated with the search objective target subject is accumulated, and the search history is not reflected.

In step S125A according to the present modification example shown in FIG. 10, the search result acquisition unit 46 determines whether or not the relationship specified in step S116 is the manager/managed subject. In a case in which the relationship is the manager/managed subject, a positive determination is made in step S125A, and the processing proceeds to step S125B.

In step S125B, the search result acquisition unit 46 determines whether or not the search objective target subject is the managed subject. In a case in which the search objective target subject is not the managed subject, in other words, in a case in which the search objective target subject is the manager, a negative determination is made in the determination in step S125B, and the processing proceeds to step S126. On the other hand, in a case in which the search objective target subject is the managed subject, a positive determination is made in the determination in step S125B, and the processing proceeds to step S125C.

In step S125C, the search result acquisition unit 46 determines whether or not the searcher and the search objective target subject are the same. In a case in which the searcher and the search objective target subject are not the same, that is, in a case in which the searcher is the manager and the search objective target subject is the managed subject, a negative determination is made in the determination, and the processing proceeds to step S126. On the other hand, in a case in which the searcher and the search objective target subject are the same, a positive determination is made in the determination in step S125C, and the processing proceeds to step S125E.

In step S125E, as in step S154 of the first processing (see FIG. 9A) described above and step S172 of the second processing (see FIG. 9B), the search result acquisition unit 46 specifies the search history associated with the search objective target subject with reference to the attribute information DB 30 stored in the storage 22C.

In next step S125F, as in step S156 of the first processing (see FIG. 9A) described above and step S174 of the second processing (see FIG. 9B), the search result acquisition unit 46 specifies the keyword from the search history specified in step S125E. The search result acquisition unit 46 outputs the keyword specified from the search history to the search result display processing unit 48.

In next step S125G, the search result display processing unit 48 decides the priority order of displaying the search result based on the search history, and then the processing proceeds to step S126. Specifically, the search result display processing unit 48 decides a higher priority order as the relation to the keyword specified in step S125F is higher.

On the other hand, in step S125A, in a case in which the relationship is not the manager/managed subject, in other words, in a case in which the relationship is equal, a negative determination is made in step S125A, and the processing proceeds to step S125D.

In step S125D, as in step S170 of the second processing (see FIG. 9B) described above, the search result acquisition unit 46 determines whether or not the searcher and the search objective target subject are the same. In a case in which the searcher and the search objective target subject are not the same, that is, in a case in which the searcher and the search objective target subject are different, a negative determination is made in the determination, and the processing proceeds to step S125E. On the other hand, in a case in which the searcher and the search objective target subject are the same, a positive determination is made in the determination, and the processing proceeds to step S126.

As a result, in step S126, the search result display processing unit 48 can display the search result in the priority order corresponding to the search history, and can reflect the search history.

It should be noted that the present disclosure is not limited to the present modification example, for example, a form may be adopted in which the search result acquisition unit 46 extracts the search result related to the keyword specified from the search history from the search result received from the search server 12 and the search result display processing unit 48 displays the extracted search result on the display unit 28.

### Modification Example 2

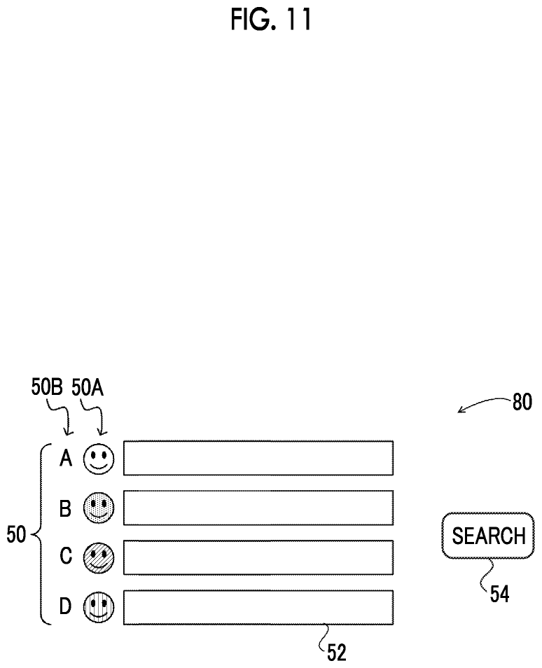

FIG. 11 shows an example of the search screen 80 displayed on the display unit 28 by the information processing apparatus 10 according to the present modification example. As shown in FIG. 11, the input field 52 is displayed for each user on the search screen 80 according to the present modification example. In this way, a form may be adopted in which the input field 52 is displayed for each user.

In the example shown in FIG. 11, the searcher inputs the search condition 60 to the input field 52 provided in accordance with the user selected as the search objective target subject. The search objective target subject reception unit 42 receives the user corresponding to the input field 52 to which the search condition 60 is input as the search objective target subject. In addition, the search condition reception unit 44 receives the search condition 60 input to the input field 52.

As described above, the information processing apparatus 10 according to each form described above is the information processing apparatus that uses any of the plurality of users including the first user and the second user as the searcher and outputs the search result obtained by the search for the search target based on the search condition designated by the searcher.

The search objective target subject reception unit 42 receives the search objective target subject selected as the search objective from among the plurality of users. The search condition reception unit 44 receives the search condition 60 designated by the searcher. In a case in which the first user is the searcher and the search objective target subject is the second user, the search result acquisition unit 46 acquires the search result obtained by the search using the search engine 13 of the search server 12 based on the keyword corresponding to the search condition 60 and outputs the acquired search result to the search result display processing unit 48. In addition, the search result acquisition unit 46 accumulates the keyword as the search history in the relationship information 30B in association with the second user who is the search objective target subject. On the other hand, in a case in which the second user is the searcher, the search result acquisition unit 46 reflects the search history to the output of the search result obtained by searching for the search target based on the keyword corresponding to the search condition 60.

For example, in a case in which the relationship is the manager/managed subject, such as a parent and a child or a boss and a subordinate, as a preliminary stage before the user who is the parent makes a decision, the user himself/herself inputs the keyword to perform the search and obtains the information necessary for making a decision. The user who is the manager (parent, boss) is responsible for the growth and behavior of the user who is the managed subject and wants the user who is the managed subject to be able to select a better decision making. There has been the only way to do the above for the user who is the manager to directly convey to the user who is the managed subject the appropriate information that would be obtained by the search, verbally or by e-mail or the like. However, there is a case in which the user who is the managed subject may perceive the above as an imposition from the user who is the manager. In such a case, the user who is the managed subject may be repelled and may not accept the information, and the advice or thought of the user manager cannot be conveyed well. In such a case, with the information processing apparatus 10 according to each form described above, the search history of the search performed by the user who is the manager as the searcher and the user who is the managed subject as the search objective target subject is accumulated and reflected to the search performed by the user who is the managed subject as the searcher, and thus it is possible to incorporate the knowledge, experience, and thought of the user who is the manager toward the user who is the managed subject into the search performed by the user who is the managed subject. That is, since “nudge” (pecking lightly with an elbow to promote better decision making) in behavioral economics can be performed, it is possible to improve the efficiency of decision making of the user who is the managed subject.

In addition, in a case of searching for an inexperienced event or the like the user who is the managed subject comes into contact with for the first time, in order to arrive at the objective information from the limited knowledge and experience of the user who is the managed subject, it is necessary to repeat trial and error. Therefore, the user who is the managed subject may ask the user who is the manager who is superior in knowledge and experience about the method, but it takes a time for the user who is the manager to understand the intention of the user who is the managed subject, and it is uncertain whether or not an accurate answer can be obtained. In such a case, with the information processing apparatus 10 according to each form described above, the search history of the search performed by the user who is the manager as the searcher and the user who is the managed subject as the search objective target subject is accumulated and reflected to the search performed by the user who is the managed subject as the searcher, and thus it is possible for the user who is the managed subject to utilize the knowledge and experience of the user who is the manager in the search without awareness.

In addition, for example, in a case in which the relationship is equal, such as a couple, a sibling, and a colleague, for example, in a case in which the couple searches for the travel destination to go on a travel, in a case in which the husband designates the wife who likes hot spring and performs the search with the search condition 60 including the two keywords 62 of “travel” and “hot spring”, the wife who is the searcher attempts to perform the search with the search condition 60 including “travel destination” as the keyword 62 by designating the husband as the search objective target subject, “hot spring” which is the keyword specified from the search history is reflected to displaying the search result of the search condition 60 including “travel destination” as the keyword 62. As a result, even in a case in which the wife performs the search by designating only “travel destination” as the search condition 60, the search result reflecting the preference of the wife is displayed. Therefore, it is possible to obtain the search result suitable for both the husband and the wife.

As described above, in the information processing apparatus 10 according to each form described above, the search history in a case in which another person designates the user himself/herself as the search objective target subject and performs the search can be accumulated and the search history can be reflected in the search, and thus it is possible to display the search result suitable for the plurality of users.

It should be noted that, in each form described above, the condition for reflecting the search history is not limited to the form shown in each form described above. For example, in a case in which the searcher is the user who is the manager and the search objective target subject is the user who is the managed subject, a form may be adopted in which the search history of the user who is the manager is also reflected.

In addition, in each form described above, the form has been described in which the information processing apparatus 10 and the search server 12 are separate bodies, but the present disclosure is not limited to the present form, and a form may be adopted in which the information processing apparatus 10 and the search server 12 may be integrated into one apparatus. In other words, the information processing apparatus 10 may include the search engine 13. Alternatively, in the present embodiment, the information processing apparatus 10 receives the input of the searcher or performs display to the searcher, but the present disclosure is not limited to this. For example, a terminal apparatus operated by the searcher may receive the input of the search objective target or the search condition of the searcher, and the information processing apparatus 10 may receive the input information received by the terminal apparatus, via the network or the like. In addition, the information processing apparatus 10 does not include the display unit 28, the search result acquired by the search result acquisition unit 46 may be transmitted to the terminal apparatus including the display unit 28 via the network or the like, and the terminal apparatus that receives the search result may perform display to the searcher.

In addition, in the form described above, for example, as the hardware structures of the processing units that execute various types of processing, such as the attribute information setting unit 40, the search objective target subject reception unit 42, the search condition reception unit 44, the search result acquisition unit 46, and the search result display processing unit 48, the following various processors can be used. As described above, in addition to a CPU which is a general-purpose processor which executes software (program) and functions as various processing units, the various processors include a programmable logic device (PLD) which is a processor of which a circuit configuration can be changed after manufacture, such as a field programmable gate array (FPGA), and a dedicated electric circuit which is a processor having a circuit configuration which is designed for exclusive use in order to execute specific processing, such as an application specific integrated circuit (ASIC).

One processing unit may be configured by one of the various processors or may be configured by a combination of two or more processors of the same type or different types (for example, a combination of a plurality of FPGAs or a combination of a CPU and an FPGA). In addition, a plurality of the processing units may be configured by one processor.

As a first example of the configuration in which a plurality of processing units are configured by one processor, as represented by a computer, such as a client and a server, there is a form in which one processor is configured by a combination of one or more CPUs and software and the processor functions as the plurality of processing units. As a second example, as represented by a system on chip (SoC) or the like, there is a form in which a processor that realizes the function of the entire system including the plurality of processing units by one integrated circuit (IC) chip is used. As described above, various processing units are configured by one or more of the various processors as the hardware structures.

Further, more specifically, an electric circuit (circuitry) obtained by combining circuit elements, such as semiconductor elements, can be used as the hardware structures of the various processors.

In addition, in the embodiment described above, an aspect has been described in which the information processing program 23 is stored (installed) in the storage 22C of the storage unit 22 in advance, but the present disclosure is not limited to this. The information processing program 23 may be provided in a form of being recorded in a recording medium, such as a compact disc read only memory (CD-ROM), a digital versatile disc read only memory (DVD-ROM), and a universal serial bus (USB) memory. In addition, each information processing program 23 may be provided in a form being downloaded from an external device via a network. That is, the program described in the present embodiment (program product) may be provided in a form of the recording medium or in a form of being distributed from an external computer.

What is claimed is:

1. An information processing apparatus that outputs a search result obtained by performing a search for a search target with any of a plurality of users including a first user and a second user as a searcher and based on a search condition designated by the searcher, the apparatus comprising:
at least one processor, wherein the processor:
receives a search objective target subject selected as a search objective from among the plurality of users;
receives the search condition designated by the searcher;
outputs a search result obtained by searching for the search target based on a keyword corresponding to the search condition and accumulates, as a search history, the keyword in association with the second user in a case in which the first user is the searcher and the search objective target subject is the second user; and
reflects the search history to output of the search result obtained by searching the search target based on the keyword corresponding to the search condition in a case in which the second user is the searcher.

2. The information processing apparatus according to claim 1, wherein the processor outputs a search result obtained by searching for the search target based on the keyword corresponding to the search condition and the search history to reflect the search history.

3. The information processing apparatus according to claim 1, wherein the processor displays the search result obtained by searching for the search target based on the keyword corresponding to the search condition in a priority order corresponding to the search history to reflect the search history.

4. The information processing apparatus according to claim 1, wherein:
attribute information indicating an attribute of each user is set for each of the plurality of users, and
the processor,
acquires the attribute information of the search objective target subject,
outputs a search result obtained by searching for the search target based on a plurality of keywords corresponding to the attribute information and the search condition and accumulates, as the search history, the keyword in association with the second user in a case in which the first user is the searcher and the search objective target subject is the second user, and
reflects the search history to output of the search result obtained by searching the search target based on the plurality of keywords corresponding to the attribute information and the search condition in a case in which the second user is the searcher.

5. The information processing apparatus according to claim 4, wherein the plurality of keywords include a keyword specified from the attribute information and a keyword specified from the search condition.

6. The information processing apparatus according to claim 4, wherein the attribute information includes relationship information indicating a relationship among the plurality of users.

7. The information processing apparatus according to claim 6, wherein the processor determines whether or not to reflect the search history based on a relationship between the first user and the second user indicated by the relationship information.

8. An information processing method executed by a processor of an information processing apparatus that includes at least one processor and outputs a search result obtained by performing a search for a search target with any of a plurality of users including a first user and a second user as a searcher and based on a search condition designated by the searcher, the method comprising:
receiving a search objective target subject selected as a search objective from among the plurality of users;
receiving the search condition designated by the searcher;
outputting a search result obtained by searching for the search target based on a keyword corresponding to the search condition and accumulating, as a search history, the keyword in association with the second user in a case in which the first user is the searcher and the search objective target subject is the second user; and
reflecting the search history to output of the search result obtained by searching the search target based on the keyword corresponding to the search condition in a case in which the second user is the searcher.

9. A non-transitory computer readable medium storing an information processing program causing a processor of an information processing apparatus that includes at least one processor and outputs a search result obtained by performing a search for a search target with any of a plurality of users including a first user and a second user as a searcher and based on a search condition designated by the searcher, to execute:
receiving a search objective target subject selected as a search objective from among the plurality of users;
receiving the search condition designated by the searcher;
outputting a search result obtained by searching for the search target based on a keyword corresponding to the search condition and accumulating, as a search history, the keyword in association with the second user in a case in which the first user is the searcher and the search objective target subject is the second user; and
reflecting the search history to output of the search result obtained by searching the search target based on the keyword corresponding to the search condition in a case in which the second user is the searcher.
